(19) United States
(12) Patent Application Publication
(10) Pub. No.: US 2022/0007075 A1
(43) Pub. Date: Jan. 6, 2022

(54) Modifying Existing Content Based on Target Audience

(71) Applicant: Apple Inc., Cupertino, CA (US)

(72) Inventor: Ian M. Richter, Los Angeles, CA (US)

(21) Appl. No.: 17/476,949

(22) Filed: Sep. 16, 2021

Related U.S. Application Data
(63) Continuation of application No. PCT/US2020/038418, filed on Jun. 18, 2020.
(60) Provisional application No. 62/867,536, filed on Jun. 27, 2019.

(51) Int. Cl. H04N 21/454; H04N 21/258; H04N 21/45; H04N 21/262; H04N 21/475

(52) U.S. Cl. CPC H04N 21/4542; H04N 21/25883; H04N 21/4756; H04N 21/26241; H04N 21/4532

(57) ABSTRACT

Existing content may be modified based on a target audience. In various implementations, a device includes a non-transitory memory and one or more processors coupled with the non-transitory memory. In some implementations, a method includes obtaining a content item. A first action performed by one or more representations of agents in the content item is identified from the content item. The method includes determining whether the first action breaches a target content rating. If the first action breaches the target content rating, a second action that satisfies the target content rating and that is within a degree of similarity to the first action is obtained. The content item is modified by replacing the first action with the second action in order to generate a modified content item that satisfies the target content rating.

### CROSS-REFERENCE TO RELATED APPLICATION

This application is a continuation of Intl. Patent App. No. PCT/US2020/38418, filed on Jun. 18, 2020, which claims priority to U.S. Provisional Patent App. No. 62/867,536, filed on Jun. 27, 2019, which are both hereby incorporated by reference in their entirety.

### TECHNICAL FIELD

The present disclosure generally relates to modifying existing content based on target audience.

### BACKGROUND

Some devices are capable of generating and presenting content. Some devices that present content include mobile communication devices, such as smartphones. Some content that may be appropriate for one audience may not be appropriate for another audience. For example, some content may include violent content or language that may be unsuitable for certain viewers.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary operating environment in accordance with some implementations.

FIGS. 2A-2B illustrate an example system that generates modified content in an environment according to various implementations.

FIG. 3A is a block diagram of an example emergent content engine in accordance with some implementations.

FIG. 3B is a block diagram of an example neural network in accordance with some implementations.

FIGS. 4A-4C are flowchart representations of a method of modifying content in accordance with some implementations.

FIG. 5 is a block diagram of a device that obfuscates location data in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for modifying existing content based on a target audience. In various implementations, a device includes a non-transitory memory and one or more processors coupled with the non-transitory memory. In some implementations, a method includes obtaining a content item. A first action performed by one or more representations of agents in the content item is identified from the content item. The method includes determining whether the first action breaches a target content rating. In response to determining that the first action breaches the target content rating, a second action that satisfies the target content rating and that is within a degree of similarity to the first action is obtained. The content item is modified by replacing the first action with the second action in order to generate a modified content item that satisfies the target content rating.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, ahead mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

XR content that may be appropriate for one audience may not be appropriate for another audience. For example, some XR content may include violent content or language that may be unsuitable for certain viewers. Different variations of XR content may be generated for different audiences. However, it is computationally expensive to generate variations of XR content for different audiences. In addition, for many content creators, developing multiple variations of the same XR content is cost-prohibitive. For example, generating an R-rated version and a PG-rated version of the same XR movie can be expensive and time-consuming. Even assuming that multiple variations of the same XR content could be generated in a cost-effective manner, it is memory intensive to store every variation of XR content.

Some implementations, e.g., for 2D assets, involve obfuscating portions of content that are inappropriate. For example, profanity may be obfuscated by sounds such as beeps. As another example, some content may be blurred or covered by colored bars. As another example, violent scenes may be skipped. Such implementations may detract from the user experience, however, and may be limited to obfuscation of content.

The present disclosure provides methods, systems, and/or devices for modifying existing extended reality (XR) content based on a target audience. In various implementations, an emergent content engine obtains existing XR content and modifies the existing XR content to generate modified XR content that is more suitable for a target audience. In some implementations, a target content rating is obtained. The target content rating may be based on the target audience. In some implementations, the target content rating is a function of an estimated age of a viewer. For example, if a young child is watching the XR content alone, the target content rating may be, e.g., G (General Audiences in the Motion Picture Association of America (MPAA) rating system for motion pictures in the United States of America) or TV-Y (rated appropriate for children of all ages in a rating system used for television content in the United States of America). On the other hand, if an adult is watching the XR content alone, the target content rating may be, e.g., R (Restricted Audiences in the MPAA rating system) or TV-MA (Mature Audiences Only in a rating system used for television content in the United States of America. If a family is watching the XR content together, the target content rating may be set to a level appropriate for the youngest person in the audience or may be configured manually, for example, by an adult.

In some implementations, one or more actions are extracted from the existing XR content. The one or more actions may be extracted, for example, using a combination of scene analysis, scene understanding, instance segmentation, and/or semantic segmentation. In some implementations, one or more actions that are to be modified are identified. For each action that is to be modified, one or more replacement actions are synthesized. The replacement actions may be down-rated (e.g., from R to G) or up-rated (e.g., from PG-13 to R).

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

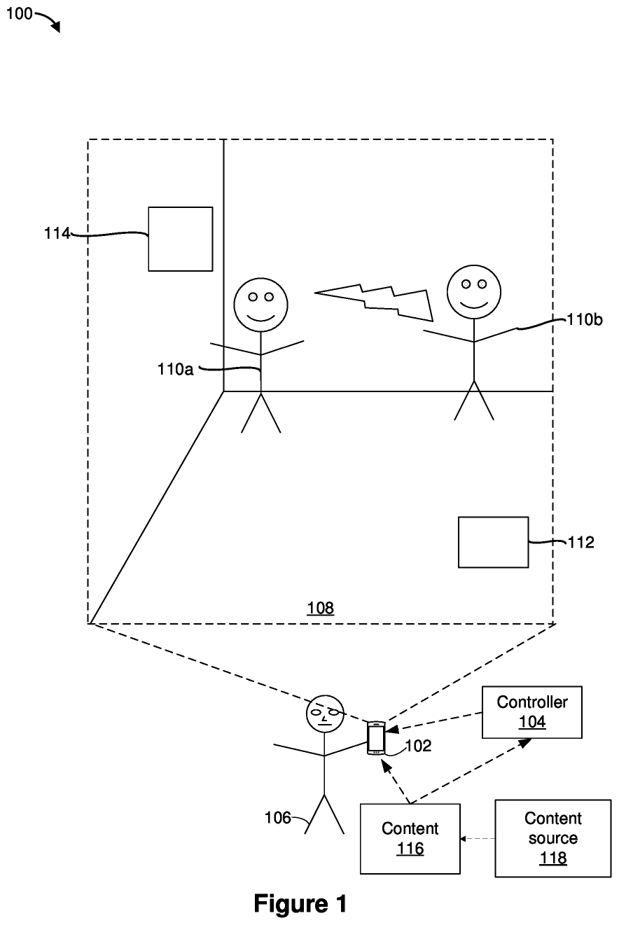

FIG. 1 illustrates an exemplary operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes an electronic device 102 and a controller 104. In some implementations, the electronic device 102 is or includes a smartphone, a tablet, a laptop computer, and/or a desktop computer. The electronic device 102 may be worn by or carried by a user 106.

As illustrated in FIG. 1, the electronic device 102 presents an extended reality (XR) environment 108. In some implementations, the XR environment 108 is generated by the electronic device 102 and/or the controller 104. In some implementations, the XR environment 108 includes a virtual scene that is a simulated replacement of a physical environment. For example, the XR environment 108 may be simulated by the electronic device 102 and/or the controller 104. In such implementations, the XR environment 108 is different from the physical environment in which the electronic device 102 is located.

In some implementations, the XR environment 108 includes an augmented scene that is a modified version of a physical environment. For example, in some implementations, the electronic device 102 and/or the controller 104 modify (e.g., augment) the physical environment in which the electronic device 102 is located in order to generate the XR environment 108. In some implementations, the electronic device 102 and/or the controller 104 generate the XR environment 108 by simulating a replica of the physical environment in which the electronic device 102 is located. In some implementations, the electronic device 102 and/or the controller 104 generate the XR environment 108 by removing and/or adding items from the simulated replica of the physical environment where the electronic device 102 is located.

In some implementations, the XR environment 108 includes various objective-effectuators such as a character representation 110a, a character representation 110b, a robot representation 112, and a drone representation 114. In some implementations, the objective-effectuators represent characters from fictional materials such as movies, video games, comics, and novels. For example, the character representation 110a may represent a character from a fictional comic, and the character representation 110b represents a character from a fictional video game. In some implementations, the XR environment 108 includes objective-effectuators that represent characters from different fictional materials (e.g., from different movies/games/comics/novels). In various implementations, the objective-effectuators represent physical entities (e.g., tangible objects). For example, in some implementations, the objective-effectuators represent equipment (e.g., machinery such as planes, tanks, robots, cars, etc.). In the example of FIG. 1, the robot representation 112 represents a robot and the drone representation 114 represents a drone. In some implementations, the objective-effectuators represent fictional entities (e.g., fictional characters or fictional equipment) from fictional material. In some implementations, the objective-effectuators represent entities from the physical environment, including things located inside and/or outside of the XR environment 108.

In various implementations, the objective-effectuators perform one or more actions. In some implementations, the objective-effectuators perform a sequence of actions. In some implementations, the electronic device 102 and/or the controller 104 determine the actions that the objective-effectuators are to perform. In some implementations, the actions of the objective-effectuators are within a degree of similarity to actions that the corresponding entities (e.g., characters or equipment) perform in the fictional material. In the example of FIG. 1, the character representation 110b is performing the action of casting a magic spell (e.g., because the corresponding character is capable of casting a magic spell in the fictional material). In the example of FIG. 1, the drone representation 114 is performing the action of hovering (e.g., because drones in the real world are capable of hovering). In some implementations, the electronic device 102 and/or the controller 104 obtain the actions for the objective-effectuators. For example, in some implementations, the electronic device 102 and/or the controller 104 receive the actions for the objective-effectuators from a remote server that determines (e.g., selects) the actions.

In various implementations, an objective-effectuator performs an action in order to satisfy (e.g., complete or achieve) an objective. In some implementations, an objective-effectuator is associated with a particular objective, and the objective-effectuator performs actions that improve the likelihood of satisfying that particular objective. In some implementations, the objective-effectuators are referred to as object representations, for example, because the objective-effectuators represent various objects (e.g., objects in the physical environment or fictional objects). In some implementations, an objective-effectuator representing a character is referred to as a character objective-effectuator. In some implementations, a character objective-effectuator performs actions to effectuate a character objective. In some implementations, an objective-effectuator representing an equipment is referred to as an equipment objective-effectuator. In some implementations, an equipment objective-effectuator performs actions to effectuate an equipment objective. In some implementations, an objective effectuator representing an environment is referred to as an environmental objective-effectuator. In some implementations, an environmental objective effectuator performs environmental actions to effectuate an environmental objective.

In various implementations, an objective-effectuator is referred to as an action-performing agent (“agent”, hereinafter for the sake of brevity). In some implementations, the agent is referred to as a virtual agent or a virtual intelligent agent. In some implementations, an objective-effectuator is referred to as an action-performing element.

In some implementations, the XR environment 108 is generated based on a user input from the user 106. For example, in some implementations, a mobile device (not shown) receives a user input indicating a terrain for the XR environment 108. In such implementations, the electronic device 102 and/or the controller 104 configure the XR environment 108 such that the XR environment 108 includes the terrain indicated via the user input. In some implementations, the user input indicates environmental conditions. In such implementations, the electronic device 102 and/or the controller 104 configure the XR environment 108 to have the environmental conditions indicated by the user input. In some implementations, the environmental conditions include one or more of temperature, humidity, pressure, visibility, ambient light level, ambient sound level, time of day (e.g., morning, afternoon, evening, or night), and precipitation (e.g., overcast, rain or snow).

In some implementations, the actions for the objective-effectuators are determined (e.g., generated) based on a user input from the user 106. For example, in some implementations, the mobile device receives a user input indicating placement of the objective-effectuators. In such implementations, the electronic device 102 and/or the controller 104 position the objective-effectuators in accordance with the placement indicated by the user input. In some implementations, the user input indicates specific actions that the objective-effectuators are permitted to perform. In such implementations, the electronic device 102 and/or the controller 104 select the actions for the objective-effectuator from the specific actions indicated by the user input. In some implementations, the electronic device 102 and/or the controller 104 forgo actions that are not among the specific actions indicated by the user input.

In some implementations, the electronic device 102 and/or the controller 104 receive existing XR content 116 from an XR content source 118. The XR content 116 may include one or more actions performed by one or more objective-effectuators (e.g., agents) to satisfy (e.g., complete or achieve) one or more objectives. In some implementations, each action is associated with a content rating. The content rating may be selected based on the type of programming represented by the XR content 116. For example, for XR content 116 that represents a motion picture, each action may be associated with a content rating according to the MPAA rating system. For XR content 116 that represents television content, each action may be associated with a content rating according to a content rating system used by the television industry. In some implementations, each action may be associated with a content rating depending on the geographical region in which the XR content 116 is viewed, as different geographical regions employ different content rating systems. Since each action may be associated with a respective rating, the XR content 116 may include actions that are associated with different ratings. In some implementations, the respective ratings of individual actions in the XR content 116 may be different from an overall rating (e.g., a global rating) associated with the XR content 116. For example, the overall rating of the XR content 116 may be PG-13, however, ratings of individual actions may range from G to PG-13.

In some implementations, content ratings associated with the one or more actions in the XR content 116 are indicated (e.g., encoded or tagged) in the XR content 116. For example, combat sequences in XR content 116 representing a motion picture may be indicated as being associated with a PG-13 or higher content rating.

In some implementations, one or more actions are extracted from the existing XR content. For example, the electronic device 102, the controller 104, or another device may extract the one or more actions using a combination of scene analysis, scene understanding, instance segmentation, and/or semantic segmentation. In some implementations, the one or more actions are indicated in the XR content 116 using metadata. For example, metadata may be used to indicate that a portion of the XR content 116 represents a combat sequence using guns. The electronic device 102, the controller 104, or another device may extract (e.g., retrieve) the one or more actions using the metadata.

In some implementations, one or more actions that are to be modified are identified. For example, the electronic device 102, the controller 104, or another device may identify the one or more actions that are to be modified by determining whether the one or more actions breach a target content rating, which may be based on the target audience. In some implementations, the target content rating is a function of an estimated age of a viewer. For example, if a young child is watching the XR content 116 alone, the target content rating may be, e.g., G or TV-Y. On the other hand, if an adult is watching the XR content 116 alone, the target content rating may be, e.g., R or TV-MA. If a family is watching the XR content 116 together, the target content rating may be set to a level appropriate for the youngest person in the audience or may be configured manually, for example, by an adult.

In some implementations, for each action that is to be modified, one or more replacement actions are synthesized, e.g., by the electronic device 102, the controller 104, and/or another device. In some implementations, the replacement actions are down-rated (e.g., from R to G). For example, a gun fight in the XR content 116 may be replaced by a first fight. As another example, objectionable language may be replaced by less objectionable language. In some implementations, the replacement actions are up-rated (e.g., from PG-13 to R). For example, an action that is implicitly violent may be replaced by a more graphically violent action.

In some implementations, a head-mountable device (HMD), being worn by a user, presents (e.g., displays) the XR environment 108 according to various implementations. In some implementations, the HMD includes an integrated display (e.g., a built-in display) that displays the XR environment 108. In some implementations, the HMD includes a head-mountable enclosure. In various implementations, the head-mountable enclosure includes an attachment region to which another device with a display can be attached. For example, in some implementations, the electronic device 102 of FIG. 1 can be attached to the head-mountable enclosure. In various implementations, the head-mountable enclosure is shaped to form a receptacle for receiving another device that includes a display (e.g., the electronic device 102). For example, in some implementations, the electronic device 102 slides or snaps into or otherwise attaches to the head-mountable enclosure. In some implementations, the display of the device attached to the head-mountable enclosure presents (e.g., displays) the XR environment 108. In various implementations, examples of the electronic device 102 include smartphones, tablets, media players, laptops, etc.

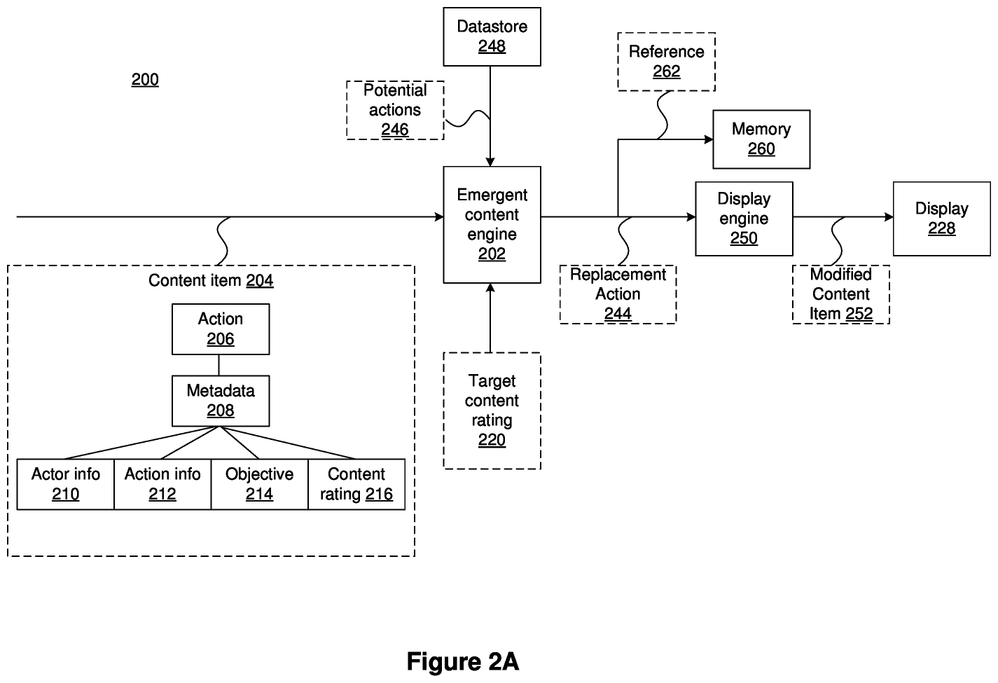

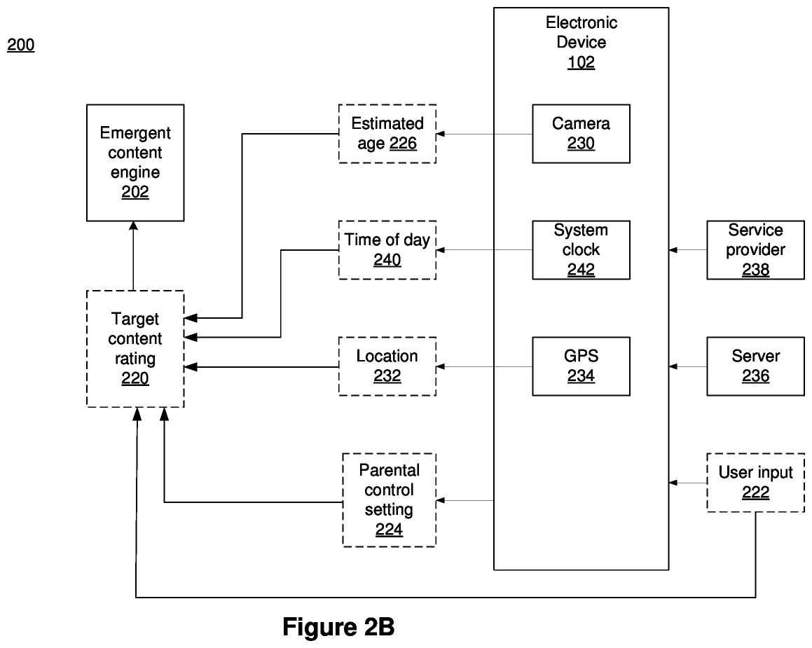

FIGS. 2A-2B illustrate an example system 200 that generates modified XR content in the XR environment 108 according to various implementations. Referring to FIG. 2A, in some implementations, an emergent content engine 202 obtains an XR content item 204 relating to the XR environment 108. In some implementations, the XR content item 204 is associated with a first content rating. In some implementations, one or more individual scenes or actions in the XR content item 204 are associated with a first content rating.

In some implementations, the emergent content engine 202 identifies a first action, e.g., an action 206, performed by an XR representation of an objective-effectuator in the XR content item 204. In some implementations, the action 206 is extracted from the XR content item 204. For example, the emergent content engine 202 may extract the action 206 using scene analysis and/or scene understanding. In some implementations, the emergent content engine 202 performs instance segmentation to identify one or more objective-effectuators that perform the action 206, e.g., to distinguish between the character representation 110a and the character representation 110b of FIGS. 1 and 1B. In some implementations, the emergent content engine 202 performs semantic segmentation to identify one or more objective-effectuators that perform the action 206, e.g., to recognize that the robot representation 112 is performing the action 206. The emergent content engine 202 may perform scene analysis, scene understanding, instance segmentation, and/or semantic segmentation to identify objects involved in the action 206, such as weapons, that may affect the content rating of the action 206 or that may cause the action 206 to breach a target content rating.

In some implementations, the emergent content engine 202 retrieves the action 206 from metadata 208 of the XR content item 204. The metadata 208 may be associated with the action 206. In some implementations, the metadata 208 includes information regarding the action 206. For example, the metadata 208 may include actor information 210 indicating an objective-effectuator that is performing the action 206. The metadata 208 may include action identifier information 212 that identifies a type of action (e.g., a combat sequence using guns, a profanity-laced monologue, etc.). In some implementations, the metadata 208 includes objective information 214 that identifies an objective that is satisfied (e.g., completed or achieved) by the action 206.

In some implementations, the metadata 208 includes content rating information 216 that indicates a content rating of the action 206. The content rating may be selected based on the type of programming represented by the XR content item 204. For example, if the XR content item 204 represents a motion picture, the content rating may be selected according to the MPAA rating system. On the other hand, if the XR content item 204 represents television content, the content rating may be selected according to a content rating system used by the television industry. In some implementations, the content rating is selected based on the geographical region in which the XR content item 204 is viewed, as different geographical regions employ different content rating systems. If the XR content item 204 is intended for viewing in multiple geographical regions, the content rating information 216 may include content ratings for multiple geographical regions. In some implementations, the content rating information 216 includes information relating to factors or considerations affecting the content rating for the action 206. For example, the content rating information 216 may include information indicating that the content rating of the action 206 was affected by violent content, language, sexual content, and/or mature themes.

In some implementations, the emergent content engine 202 determines whether the action 206 breaches a target content rating 220. For example, if the metadata 208 includes content rating information 216, the emergent content engine 202 may compare the content rating information 216 with the target content rating 220. If the metadata 208 does not include content rating information 216, or if the action 206 is not associated with metadata 208, the emergent content engine 202 may evaluate the action 206, as determined by, e.g., scene analysis, scene understanding, instance segmentation, and/or semantic segmentation, against the target content rating 220 to determine whether the action 206 breaches the target content rating 220.

The target content rating 220 may be based on the target audience. In some implementations, the target content rating is a function of an estimated age of a viewer. For example, if a young child is watching the XR content item 204 alone, the target content rating may be, e.g., G or TV-Y. On the other hand, if an adult is watching the XR content item 204 alone, the target content rating 220 may be, e.g., R or TV-MA. If a family is watching the XR content item 204 together, the target content rating 220 may be set to a level appropriate for the youngest person in the audience or may be configured manually, for example, by an adult. In some implementations, the target content rating 220 includes information relating to factors or considerations affecting the content rating for the action 206. For example, the target content rating 220 may include information indicating that if the action 206 breaches the target content rating 220 because it includes adult language or sexual content, the action 206 is to be modified. The target content rating 220 may include information indicating that if the action 206 breaches the target content rating 220 because it includes a depiction of violence, the action 206 is to be displayed without modification.

Referring to FIG. 2B, the emergent content engine 202 may obtain the target content rating 220 in any of a variety of ways. In some implementations, for example, the emergent content engine 202 detects a user input 222, e.g., from the electronic device 102 indicative of the target content rating 220. In some implementations, the user input 222 includes, for example, a parental control setting 224. The parental control setting 224 may specify a threshold content rating, such that content above the threshold content rating is not allowed to be displayed. In some implementations, the parental control setting 224 specifies particular content that is allowed or not allowed to be displayed. For example, the parental control setting 224 may specify that violence may be displayed, but sexual content may not be displayed. In some implementations, the parental control setting 224 may be set as a profile, e.g., a default profile, on the electronic device 102.

In some implementations, the emergent content engine 202 obtains the target content rating 220 based on an estimated age 226 of a target viewer viewing a display 228 coupled with the electronic device 102. For example, in some implementations, the emergent content engine 202 determines the estimated age 226 of the target viewer. The estimated age 226 may be based on a user profile, e.g., a child profile or an adult profile. In some implementations, the estimated age 226 is determined based on input from a camera 230. The camera 230 may be coupled with the electronic device 102 or may be a separate device.

In some implementations, the emergent content engine 202 obtains the target content rating 220 based on a geographical location 232 of a target viewer. For example, in some implementations, the emergent content engine 202 determines the geographical location 232 of the target viewer. This determination may be based on a user profile. In some implementations, the emergent content engine 202 determines the geographical location 232 of the target viewer based on input from a GPS system 234 associated with the electronic device 102. In some implementations, the emergent content engine 202 determines the geographical location 232 of the target viewer based on a server 236 with which the emergent content engine 202 is in communication, e.g., an Internet Protocol (IP) address associated with the server 236. In some implementations, the emergent content engine 202 determines the geographical location 232 of the target viewer based on a service provider 238 with which the emergent content engine 202 is in communication, e.g., a cell tower. In some implementations, the target content rating 220 may be obtained based on the type of location in which a target viewer is located. For example, the target content rating 220 may be lower if the target viewer is located in a school or church. The target content rating 220 may be higher if the target viewer is located in a bar or nightclub.

In some implementations, the emergent content engine 202 obtains the target content rating 220 based on a time of day 240. For example, in some implementations, the emergent content engine 202 determines the time of day 240. In some implementations, the emergent content engine 202 determines the time of day 240 based on input from a clock, e.g., a system clock 242 associated with the electronic device 102. In some implementations, the emergent content engine 202 determines the time of day 240 based on the server 236, e.g., an Internet Protocol (IP) address associated with the server 236. In some implementations, the emergent content engine 202 determines the time of day 240 based on the service provider 238, e.g., a cell tower. In some implementations, the target content rating 220 may have a lower value during certain hours, e.g., during daytime hours, and a higher value during other hours, e.g., during nighttime hours. For example, the target content rating 220 may be PG during the daytime and R at night.

In some implementations, on a condition that the action 206 breaches the target content rating 220, the emergent content engine 202 obtains a second action, e.g., a replacement action 244. The emergent content engine 202 may obtain one or more potential actions 246. The emergent content engine 202 may retrieve the one or more potential actions 246 from a datastore 248. In some implementations, the emergent content engine 202 synthesizes the one or more potential actions 246.

In some implementations, the replacement action 244 satisfies the target content rating 220. For example, the emergent content engine 202 may query the datastore 248 to return potential actions 246 having a content rating that is above the target content rating 220 or below the target content rating 220. In some implementations, the emergent content engine 202 down-rates the action 206 and selects a potential action 246 that has a lower content rating than the action 206. In some implementations, the emergent content engine 202 up-rates the action 206 and selects a potential action 246 that has a higher content rating than the action 206.

In some implementations, the replacement action 244 is within a degree of similarity to the action 206. For example, the emergent content engine 202 may query the datastore 248 to return potential actions 246 that are within a threshold degree of similarity to the action 206. Accordingly, if the action 206 to be replaced is a gunshot, the set of potential actions 246 may include a punch or a kick but may exclude an exchange of gifts, for example, because an exchange of gifts is too dissimilar to a gunshot.

In some implementations, the replacement action 244 satisfies (e.g., completes or achieves) the same objective as the action 206, e.g., the objective information 214 indicated by the metadata 208. For example, the emergent content engine 202 may query the datastore 248 to return potential actions 246 that satisfy the same objective as the action 206. In some implementations, for example, if the metadata 208 does not indicate an objective satisfied by the action 206, the emergent content engine 202 determines an objective that the action 206 satisfies and selects the replacement action 244 based on that objective.

In some implementations, the emergent content engine 202 obtains a set of potential actions 246 that may be candidate actions. The emergent content engine 202 may select the replacement action 244 from the candidate actions based on one or more criteria. In some implementations, the emergent content engine 202 selects the replacement action 244 based on the degree of similarity between a particular candidate action and the action 206. In some implementations, the emergent content engine 202 selects the replacement action 244 based on a degree to which a particular candidate action satisfies an objective satisfied by the action 206.

In some implementations, the emergent content engine 202 provides the replacement action 244 to a display engine 250. The display engine 250 modifies the XR content item 204 by replacing the action 206 with the replacement action 244 to generate a modified XR content item 252. For example, the display engine 250 modifies pixels and/or audio data of the XR content item 204 to represent the replacement action 244. In this way, the system 200 generates a modified XR content item 252 that satisfies the target content rating 220.

In some implementations, the system 200 presents the modified XR content item 252. For example, in some implementations, the display engine 250 provides the modified XR content item 252 to a rendering and display pipeline. In some implementations, the display engine 250 transmits the modified XR content item 252 to another device that displays the modified XR content item 252.

In some implementations, the system 200 stores the modified XR content item 252 by storing the replacement action 244. For example, the emergent content engine 202 may provide the replacement action 244 to a memory 260. The memory 260 may store the replacement action 244 with a reference 262 to the XR content item 204. Accordingly, storage space utilization may be reduced, e.g., relative to storing the entire modified XR content item 252.

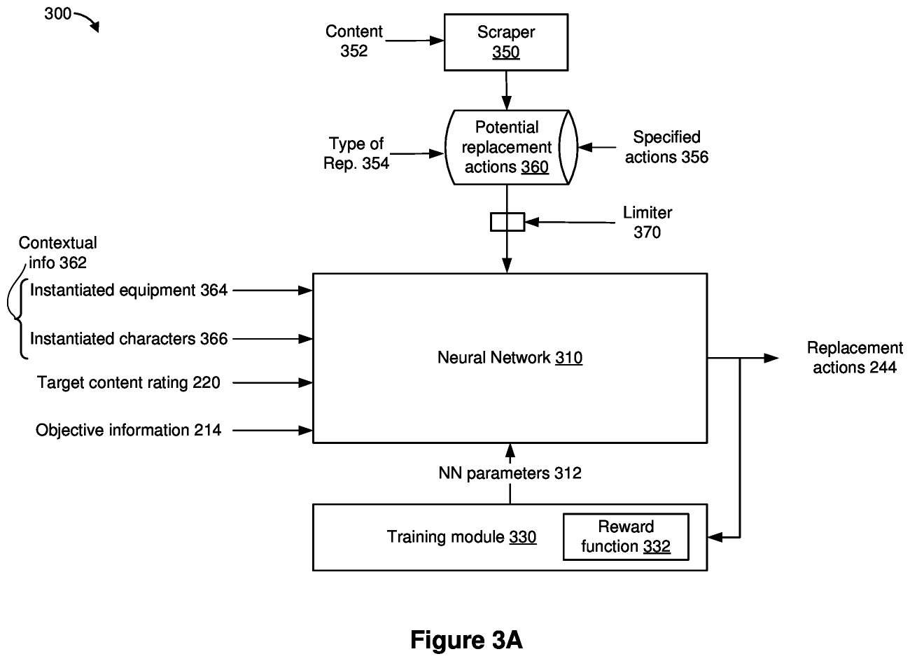

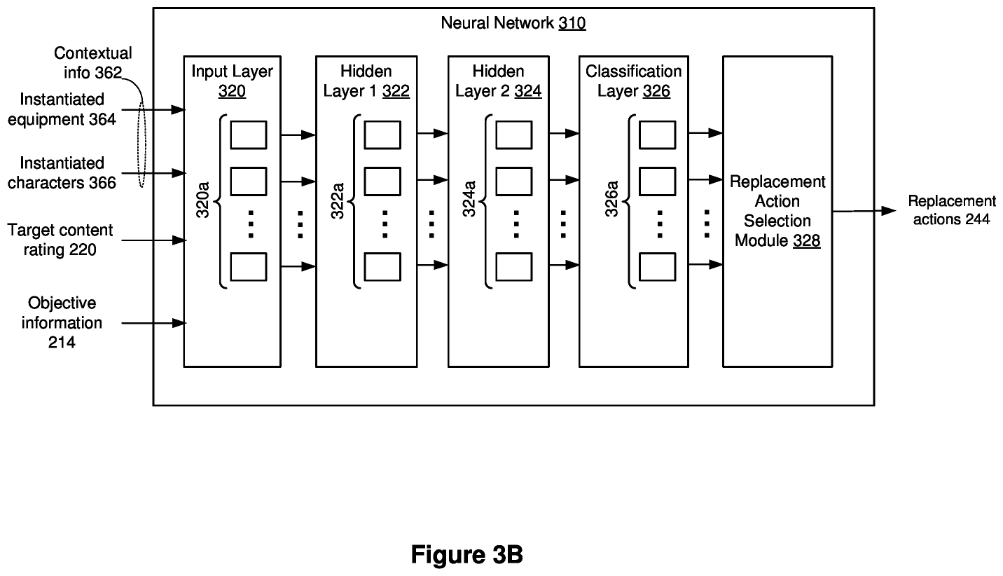

FIG. 3A is a block diagram of an example emergent content engine 300 in accordance with some implementations. In some implementations, the emergent content engine 300 implements the emergent content engine 202 shown in FIG. 2. In some implementations, the emergent content engine 300 generates candidate replacement actions for various objective-effectuators that are instantiated in an XR environment (e.g., character or equipment representations such as the character representation 110a, the character representation 110b, the robot representation 112, and/or the drone representation 114 shown in FIGS. 1 and 1B).

In various implementations, the emergent content engine 300 includes a neural network system 310 (“neural network 310”, hereinafter for the sake of brevity), a neural network training system 330 (“training module 330”, hereinafter for the sake of brevity) that trains (e.g., configures) the neural network 310, and a scraper 350 that provides potential replacement actions 360 to the neural network 310. In various implementations, the neural network 310 generates a replacement action, e.g., the replacement action 244 shown in FIG. 2, to replace an action that breaches a target content rating, e.g., the target content rating 220.

In some implementations, the neural network 310 includes a long short-term memory (LSTM) recurrent neural network (RNN). In various implementations, the neural network 310 generates the replacement action 244 based on a function of the potential replacement actions 360. For example, in some implementations, the neural network 310 generates replacement actions 244 by selecting a portion of the potential replacement actions 360. In some implementations, the neural network 310 generates replacement actions 244 such that the replacement actions 244 are within a degree of similarity to the potential replacement actions 360 and/or to the action that is to be replaced.

In various implementations, the neural network 310 generates the replacement action 244 based on contextual information 362 characterizing the XR environment 108. As illustrated in FIG. 3A, in some implementations, the contextual information 362 includes instantiated equipment representations 364 and/or instantiated character representations 366. The neural network 310 may generate the replacement action based on a target content rating, e.g., the target content rating 220, and/or objective information, e.g., the objective information 214 from the metadata 208.

In some implementations, the neural network 310 generates the replacement action 244 based on the instantiated equipment representations 364, e.g., based on the capabilities of a given instantiated equipment representation 364. In some implementations, the instantiated equipment representations 364 refer to equipment representations that are located in the XR environment 108. For example, referring to FIGS. 1 and 1B, the instantiated equipment representations 364 include the robot representation 112 and the drone representation 114 in the XR environment 108. In some implementations, the replacement action 244 may be performed by one of the instantiated equipment representations 364. For example, referring to FIGS. 1 and 1B, in some implementations, the XR content item may include an action in which the robot representation 112 fires a disintegration ray. If the action of firing a disintegration ray breaches the target content rating, the neural network 310 may generate a replacement action 244 that is within the capabilities of the robot representation 112 and that satisfies the target content rating, such as firing a stun ray.

In some implementations, the neural network 310 generates the replacement action 244 for a character representation based on the instantiated character representations 366, e.g., based on the capabilities of a given instantiated character representation 366. For example, referring to FIGS. 1 and 1B, the instantiated character representations 366 include the character representations 110a and 110b. In some implementations, the replacement action 244 may be performed by one of the instantiated character representations 366. For example, referring to FIGS. 1 and 1B, in some implementations, the XR content item may include an action in which an instantiated character representation 366 fires a gun. If the action of firing a gun breaches the target content rating, the neural network 310 may generate a replacement action 244 that is within the capabilities of the instantiated character representation 366 and that satisfies the target content rating. In some implementations, different instantiated character representations 366 may have different capabilities and may result in the generation of different replacement actions 244. For example, if the character representation 110a represents a normal human, the neural network 310 may generate a punch as the replacement action 244. On the other hand, if the character representation 110b represents a superpowered human, the neural network 310 may instead generate a nonlethal energy attack as the replacement action 244.

In various implementations, the training module 330 trains the neural network 310. In some implementations, the training module 330 provides neural network (NN) parameters 312 to the neural network 310. In some implementations, the neural network 310 includes model(s) of neurons, and the neural network parameters 312 represent weights for the model(s). In some implementations, the training module 330 generates (e.g., initializes or initiates) the neural network parameters 312, and refines (e.g., adjusts) the neural network parameters 312 based on the replacement actions 244 generated by the neural network 310.

In some implementations, the training module 330 includes a reward function 332 that utilizes reinforcement learning to train the neural network 310. In some implementations, the reward function 332 assigns a positive reward to replacement actions 244 that are desirable and a negative reward to replacement actions 244 that are undesirable. In some implementations, during a training phase, the training module 330 compares the replacement actions 244 with verification data that includes verified actions, e.g., actions that are known to satisfy the objectives of the objective-effectuator and/or that are known to satisfy the target content rating 220. In such implementations, if the replacement actions 244 are within a degree of similarity to the verified actions, then the training module 330 stops training the neural network 310. However, if the replacement actions 244 are not within the degree of similarity to the verified actions, then the training module 330 continues to train the neural network 310. In various implementations, the training module 330 updates the neural network parameters 312 during/after the training.

In various implementations, the scraper 350 scrapes content 352 to identify the potential replacement actions 360, e.g., actions that are within the capabilities of a character represented by a representation. In some implementations, the content 352 includes movies, video games, comics, novels, and fan-created content such as blogs and commentary. In some implementations, the scraper 350 utilizes various methods, systems, and/or devices associated with content scraping to scrape the content 352. For example, in some implementations, the scraper 350 utilizes one or more of text pattern matching, HTML (Hyper Text Markup Language) parsing, DOM (Document Object Model) parsing, image processing and audio analysis to scrape the content 352 and identify the potential replacement actions 360.

In some implementations, an objective-effectuator is associated with a type of representation 354, and the neural network 310 generates the replacement actions 244 based on the type of representation 354 associated with the objective-effectuator. In some implementations, the type of representation 354 indicates physical characteristics of the objective-effectuator (e.g., color, material type, texture, etc.). In such implementations, the neural network 310 generates the replacement actions 244 based on the physical characteristics of the objective-effectuator. In some implementations, the type of representation 354 indicates behavioral characteristics of the objective-effectuator (e.g., aggressiveness, friendliness, etc.). In such implementations, the neural network 310 generates the replacement actions 244 based on the behavioral characteristics of the objective-effectuator. For example, the neural network 310 generates a replacement action 244 of throwing a punch for the character representation 110a in response to the behavioral characteristics including aggressiveness. In some implementations, the type of representation 354 indicates functional and/or performance characteristics of the objective-effectuator (e.g., strength, speed, flexibility, etc.). In such implementations, the neural network 310 generates the replacement actions 244 based on the functional characteristics of the objective-effectuator. For example, the neural network 310 generates a replacement action 244 of projecting a stun ray for the character representation 110b in response to the functional and/or performance characteristics including the ability to project a stun ray. In some implementations, the type of representation 354 is determined based on a user input. In some implementations, the type of representation 354 is determined based on a combination of rules.

In some implementations, the neural network 310 generates the replacement actions 244 based on specified actions 356. In some implementations, the specified actions 356 are provided by an entity that controls (e.g., owns or creates) the fictional material from which the character or equipment originated. For example, in some implementations, the specified actions 356 are provided by a movie producer, a video game creator, a novelist, etc. In some implementations, the potential replacement actions 360 include the specified actions 356. As such, in some implementations, the neural network 310 generates the replacement actions 244 by selecting a portion of the specified actions 356.

In some implementations, the potential replacement actions 360 for an objective-effectuator are limited by a limiter 370. In some implementations, the limiter 370 restricts the neural network 310 from selecting a portion of the potential replacement actions 360. In some implementations, the limiter 370 is controlled by the entity that owns (e.g., controls) the fictional material from which the character or equipment originated. For example, in some implementations, the limiter 370 is controlled by a movie producer, a video game creator, a novelist, etc. In some implementations, the limiter 370 and the neural network 310 are controlled/operated by different entities.

In some implementations, the limiter 370 restricts the neural network 310 from generating replacement actions that breach a criterion defined by the entity that controls the fictional material. For example, the limiter 370 may restrict the neural network 310 from generating replacement actions that would be inconsistent with the character represented by a representation. In some implementations, the limiter 370 restricts the neural network 310 from generating replacement actions that change the content rating of an action by more than a threshold amount. For example, the limiter 370 may restrict the neural network 310 from generating replacement actions with content ratings that differ from the content rating of the original action by more than the threshold amount. In some implementations, the limiter 370 restricts the neural network 310 from generating replacement actions for certain actions. For example, the limiter 370 may restrict the neural network 310 from replacing certain actions designated as, e.g., essential by an entity that owns (e.g., controls) the fictional material from which the character or equipment originated.

FIG. 3B is a block diagram of the neural network 310 in accordance with some implementations. In the example of FIG. 3B, the neural network 310 includes an input layer 320, a first hidden layer 322, a second hidden layer 324, a classification layer 326, and a replacement action selection module 328. While the neural network 310 includes two hidden layers as an example, those of ordinary skill in the art will appreciate from the present disclosure that one or more additional hidden layers are also present in various implementations. Adding additional hidden layers adds to the computational complexity and memory demands but may improve performance for some applications.

In various implementations, the input layer 320 receives various inputs. In some implementations, the input layer 320 receives the contextual information 362 as input. In the example of FIG. 3B, the input layer 320 receives inputs indicating the instantiated equipment representations 364, the instantiated character representations 366, the target content rating 220, and/or the objective information 214 from the objective-effectuator engines. In some implementations, the neural network 310 includes a feature extraction module (not shown) that generates a feature stream (e.g., a feature vector) based on the instantiated equipment representations 364, the instantiated character representations 366, the target content rating 220, and/or the objective information 214. In such implementations, the feature extraction module provides the feature stream to the input layer 320. As such, in some implementations, the input layer 320 receives a feature stream that is a function of the instantiated equipment representations 364, the instantiated character representations 366, the target content rating 220, and/or the objective information 214. In various implementations, the input layer 320 includes one or more LSTM logic units 320a, which are also referred to as neurons or models of neurons by those of ordinary skill in the art. In some such implementations, an input matrix from the features to the LSTM logic units 320a includes rectangular matrices. The size of this matrix is a function of the number of features included in the feature stream.

In some implementations, the first hidden layer 322 includes one or more LSTM logic units 322a. In some implementations, the number of LSTM logic units 322a ranges between approximately 10-500. Those of ordinary skill in the art will appreciate that, in such implementations, the number of LSTM logic units per layer is orders of magnitude smaller than previously known approaches (e.g., being of the order of O(10¹)-O(10²)), which facilitates embedding such implementations in highly resource-constrained devices. As illustrated in the example of FIG. 3B, the first hidden layer 322 receives its inputs from the input layer 320.

In some implementations, the second hidden layer 324 includes one or more LSTM logic units 324a. In some implementations, the number of LSTM logic units 324a is the same as or similar to the number of LSTM logic units 320a in the input layer 320 or the number of LSTM logic units 322a in the first hidden layer 322. As illustrated in the example of FIG. 3B, the second hidden layer 324 receives its inputs from the first hidden layer 322. Additionally or alternatively, in some implementations, the second hidden layer 324 receives its inputs from the input layer 320.

In some implementations, the classification layer 326 includes one or more LSTM logic units 326a. In some implementations, the number of LSTM logic units 326a is the same as or similar to the number of LSTM logic units 320a in the input layer 320, the number of LSTM logic units 322a in the first hidden layer 322, or the number of LSTM logic units 324a in the second hidden layer 324. In some implementations, the classification layer 326 includes an implementation of a multinomial logistic function (e.g., a soft-max function) that produces a number of outputs that is approximately equal to the number of potential replacement actions 360. In some implementations, each output includes a probability or a confidence measure of the corresponding objective being satisfied by the replacement action in question. In some implementations, the outputs do not include objectives that have been excluded by operation of the limiter 370.

In some implementations, the replacement action selection module 328 generates the replacement actions 244 by selecting the top N replacement action candidates provided by the classification layer 326. In some implementations, the top N replacement action candidates are likely to satisfy the objective of the objective-effectuator, satisfy the target content rating 220, and/or are within a degree of similarity to the action that is to be replaced. In some implementations, the replacement action selection module 328 provides the replacement actions 244 to a rendering and display pipeline (e.g., the display engine 250 shown in FIG. 2). In some implementations, the replacement action selection module 328 provides the replacement actions 244 to one or more objective-effectuator engines.

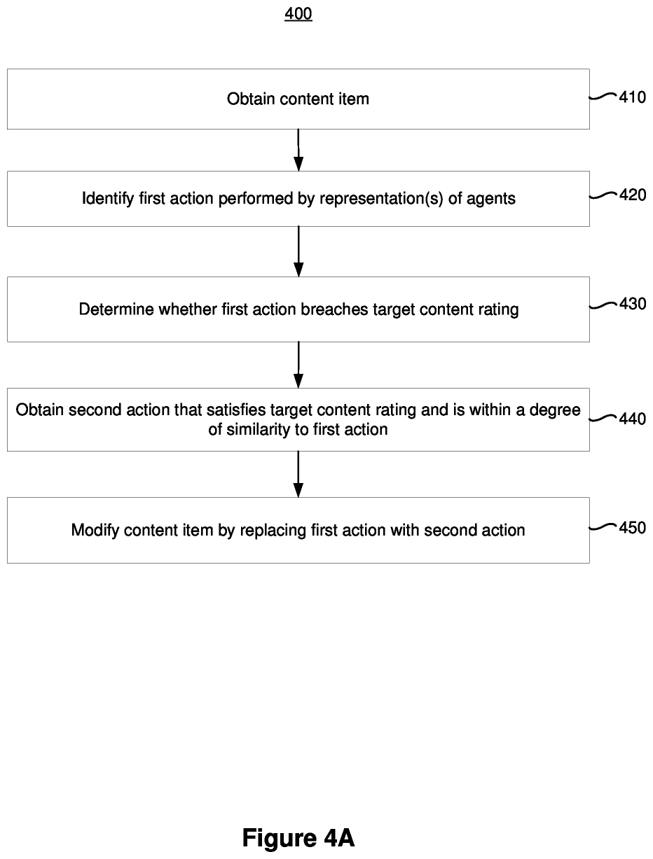

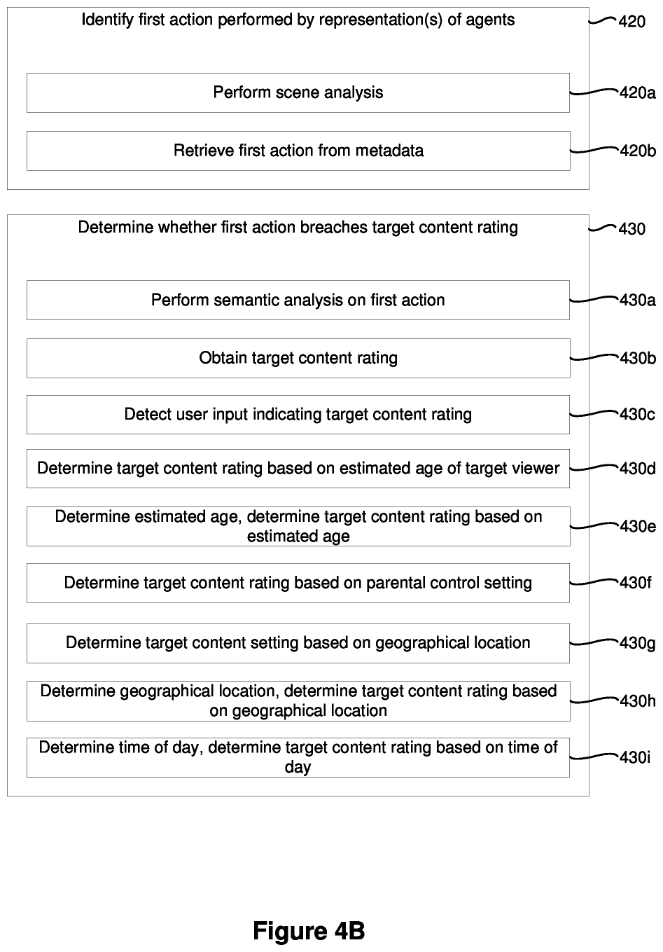

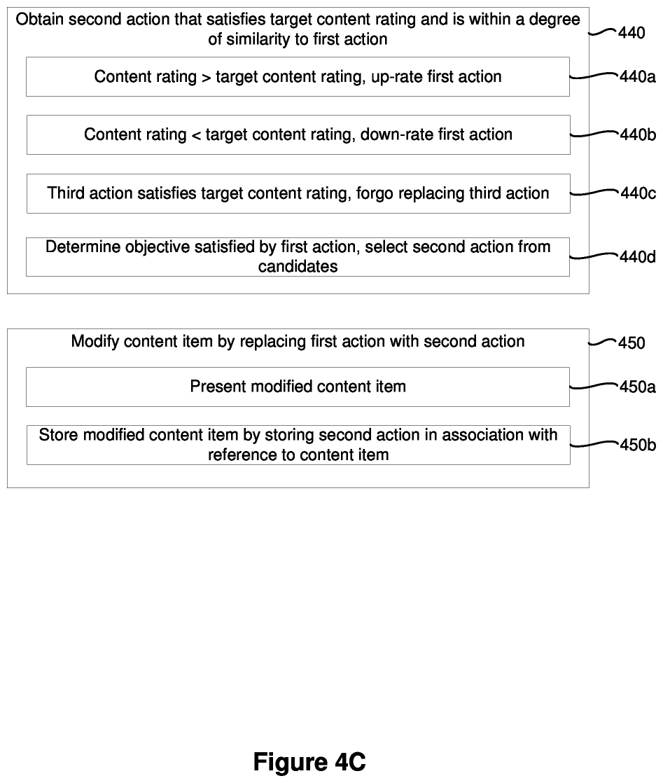

FIGS. 4A-4C are a flowchart representation of a method 400 for modifying XR content in accordance with some implementations. In various implementations, the method 400 is performed by a device (e.g., the system 200 shown in FIG. 2). In some implementations, the method 400 is performed by processing logic, including hardware, firmware, software, or a combination thereof. In some implementations, the method 400 is performed by a processor executing code stored in a non-transitory computer-readable medium (e.g., a memory). Briefly, in various implementations, the method 400 includes obtaining an XR content item, identifying a first action performed by one or more XR representations of objective-effectuators in the XR content item, determining whether the first item breaches a target content rating and, if so, obtaining a second action that satisfies the target content rating and that is within a degree of similarity to the first action. The XR content item is modified by replacing the first action with the second action in order to generate a modified XR content item that satisfies the target content rating.

As represented by block 410, in various implementations, the method 400 includes obtaining an XR content item that is associated with a first content rating. For example, in some implementations, the XR content item may be an XR motion picture. In some implementations, the XR content item may be television programming.

As represented by block 420, in various implementations, the method 400 includes identifying, from the XR content item, a first action performed by one or more XR representations of objective-effectuators in the XR content item. For example, referring now to FIG. 4B, as represented by block 420a, in some implementations, scene analysis is performed on the XR content item to identify the one or more XR representations of the objective-effectuators and to determine the first action performed by the one or more XR representations of the objective-effectuators. In some implementations, scene analysis involves performing semantic segmentation to identify a type of objective-effectuator that is performing an action, the action being performed, and/or an instrumentality that is employed to perform the action, for example. Scene analysis may involve performing instance segmentation, for example, to distinguish between multiple instances of similar types of objective-effectuators (e.g., to determine whether an action is performed by a character representation 110a or by a character representation 110b).

As represented by block 420b, in some implementations, the method 400 includes retrieving the first action from metadata of the XR content item. In some implementations, the metadata is associated with the first action. In some implementations, the metadata includes information regarding the first action. For example, the metadata may indicate an objective-effectuator that is performing the action. The metadata may identify a type of action (e.g., a combat sequence using guns, a profanity-laced monologue, etc.). In some implementations, the metadata identifies an objective that is satisfied (e.g., completed or achieved) by the action.

As represented by block 430, in various implementations, the method 400 includes determining whether the first action breaches a target content rating. The first action may breach the target content rating by exceeding the target content rating or by being less than the target content rating.

As represented by block 430a, in some implementations, semantic analysis is performed on the first action to determine whether the first action breaches the target content rating. If the first action does not have a content rating associated with it, for example, in metadata, the emergent content engine 202 may apply semantic analysis to determine whether the first action involves violent content, adult language, or any other factors that may cause the first action to breach the target content rating.

As represented by block 430b, in some implementations, the method 400 includes obtaining the target content rating. The target content rating may be obtained in any of a variety of ways. In some implementations, for example, a user input from the electronic device may be detected, as represented by block 430c. The user input may indicate the target content rating.

As represented by block 430d, in some implementations, the method 400 includes determining the target content rating based on an estimated age of a target viewer. In some implementations, as represented by block 430e, the estimated age is determined, and the target content rating is determined based on the estimated age. For example, an electronic device may capture an image of the target viewer and perform image analysis to estimate the age of the target viewer. In some implementations, the estimated age may be determined based on a user profile. For example, an XR application may have multiple profiles associated with it, each profile corresponding to a member of a family. Each profile may be associated with the actual age of the corresponding family member or may be associated with broader age categories (e.g., preschool, school age, teenager, adult, etc.). In some implementations, the estimated age may be determined based on a user input. For example, the target viewer may be asked to input his or her age or birthdate. In some implementations, multiple target viewers may be present. In such implementations, the target content rating may be determined based on the age of one of the target viewers, e.g., the youngest target viewer.

In some implementations, as represented by block 430f, the method 400 includes determining the target content rating based on a parental control setting, which may be set as a profile or by user input. The parental control setting may specify a threshold content rating. XR content above the target content rating is not allowed to be displayed. In some implementations, the parental control setting specifies different target content ratings for different types of content. For example, the parental control setting may specify that violence up to a first target content rating may be displayed and that sexual content up to a second target content rating, different from the first target content rating, may be displayed. Parents can set the first and second target content ratings individually according to their preferences regarding violence and sexual content, respectively.

In some implementations, as represented by block 430g, the method 400 includes determining the target content rating based on a geographical location of a target viewer. For example, in some implementations, as represented by block 430h, the geographical location of the target viewer may be determined, and that geographical location may be used to determine the target content rating. In some implementations, a user profile may specify the geographical location of the target viewer. In some implementations, the geographical location may be determined based on input from a GPS system. In some implementations, the geographical location of the target viewer may be determined based on a server, e.g., based on an Internet Protocol (IP) address of the server. In some implementations, the geographical location of the target viewer may be determined based on a wireless service provider, e.g., a cell tower. In some implementations, the geographical location may be associated with a type of location, and the target content rating may be determined based on the location type. For example, the target content rating may be lower if the target viewer is located in a school or church. The target content rating may be higher if the target viewer is located in a bar or nightclub.

As represented by block 430i, in some implementations, a time of day is determined, and the target content rating is determined based on the time of day. In some implementations, the time of day is determined based on input from a clock, e.g., a system clock. In some implementations, the time of day is determined based on an external time reference, such as a server or a wireless service provider, e.g., a cell tower. In some implementations, the target content rating may have a lower value during certain hours, e.g., during daytime hours, and a higher value during other hours, e.g., during nighttime hours. For example, the target content rating may be PG during the daytime and R at night.

Referring now to FIG. 4C, as represented by block 440, the method 400 includes obtaining a second action that satisfies the target content rating and that is within a degree of similarity to the first action on a condition that the first action breaches the target content rating. For example, as represented by block 440a, in some implementations, the content rating of the XR content item or of a portion of the XR content item, such as the first action, is higher than the target content rating. In some implementations, the replacement actions are down-rated (e.g., from R to G). For example, a gun fight in the XR content may be replaced by a first fight. As another example, objectionable language may be replaced by less objectionable language.

As represented by block 440b, in some implementations, the content rating of the XR content item or of a portion of the XR content item, such as the first action, is lower than the target content rating. For example, this difference may indicate that the target viewer wishes to see edgier content than the XR content item depicts. In some implementations, the replacement actions are up-rated (e.g., from PG-13 to R). For example, a first fight may be replaced by a gun fight. As another example, the amount of blood and gore displayed in a fight scene may be increased.

As represented by block 440c, in some implementations, a third action performed by one or more XR representations of objective-effectuators in the XR content item satisfies the target content rating. For example, in some implementations, a content rating associated with the third action is the same as the target content rating. Accordingly, the system may forgo or omit replacing the third action in the XR content item. As a result, the content rating may be maintained at its current level.

In some implementations, as represented by block 440d, the method 400 includes determining an objective that is satisfied by the first action. For example, the system may determine which objective or objectives associated with an objective-effectuator performing the first action is completed or achieved by the first action. When selecting a replacement action, the system may give preference to candidate actions that satisfy (e.g., complete or achieve) the same objective or objectives as the first action. For example, if the first action is firing a gun and the candidate actions are throwing a punch or running away, the system may throwing a punch as the replacement action because that candidate action satisfies the same objective as firing a gun.

As represented by block 450, in some implementations, the method 400 includes modifying the XR content item by replacing the first action with the second action. Accordingly, a modified XR content item is generated. The modified XR content item satisfies the target content rating. As represented by block 450a, the modified XR content item may be presented, e.g., to the target viewer. For example, the modified XR content may be provided to a rendering and display pipeline. In some implementations, the modified XR content may be transmitted to another device. In some implementations, the modified XR content may be displayed on a display coupled with the electronic device.

As represented by block 450b, in some implementations, the modified XR content item may be stored, e.g., in a memory by storing the selected replacement action with a reference to the XR content item. Storing the modified XR content item in this way may reduce storage space utilization as compared with storing the entire modified XR content item.

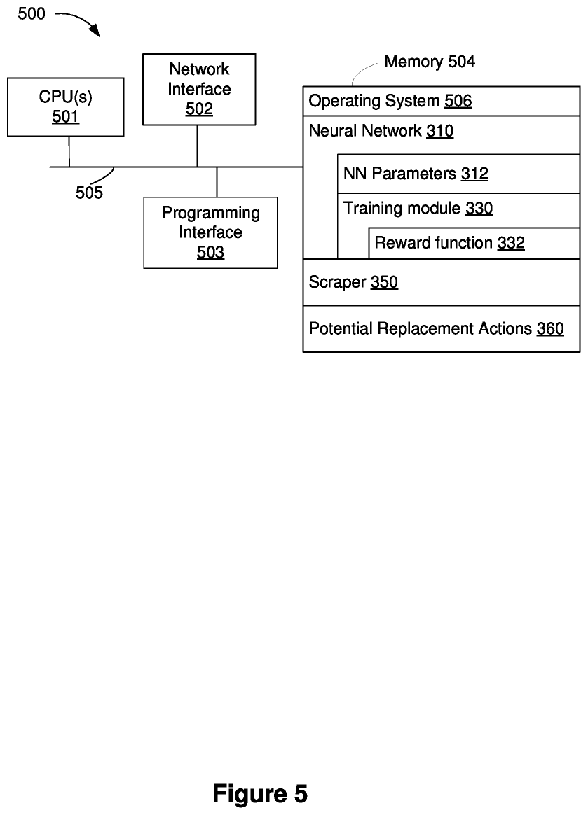

FIG. 5 is a block diagram of a server system 500 enabled with one or more components of a device (e.g., the electronic device 102 and/or the controller 104 shown in FIG. 1) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the server system 500 includes one or more processing units (CPUs) 501, a network interface 502, a programming interface 503, a memory 504, and one or more communication buses 505 for interconnecting these and various other components.

In some implementations, the network interface 502 is provided to, among other uses, establish, and maintain a metadata tunnel between a cloud hosted network management system and at least one private network including one or more compliant devices. In some implementations, the one or more communication buses 505 include circuitry that interconnects and controls communications between system components. The memory 504 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 504 optionally includes one or more storage devices remotely located from the one or more CPUs 501. The memory 504 comprises a non-transitory computer readable storage medium.

In some implementations, the memory 504 or the non-transitory computer readable storage medium of the memory 504 stores the following programs, modules and data structures, or a subset thereof including an optional operating system 506, the neural network 310, the training module 330, the scraper 350, and the potential replacement actions 360. As described herein, the neural network 310 is associated with the neural network parameters 312. As described herein, the training module 330 includes a reward function 332 that trains (e.g., configures) the neural network 310 (e.g., by determining the neural network parameters 312). As described herein, the neural network 310 determines replacement actions (e.g., the replacement actions 244 shown in FIGS. 2-3B) for objective-effectuators in an XR environment and/or for the environment of the XR environment.

It will be appreciated that FIG. 5 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 5 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a non-transitory memory and one or more processors coupled with the non-transitory memory:
obtaining a content item;
identifying, from the content item, a first action performed by one or more representations of agents;
determining whether the first action breaches a target content rating; and
in response to determining that the first action breaches the target content rating:
obtaining a second action that satisfies the target content rating and that is within a degree of similarity to the first action; and
replacing the first action with the second action in order to satisfy the target content rating.

2. The method of claim 1, further comprising performing scene analysis on the content item to identify the one or more representations of the agents and to identify the first action performed by the one or more representations of the agents.

3. The method of claim 1, further comprising performing semantic analysis on the first action to determine whether the first action breaches the target content rating.

4. The method of claim 3, further comprising obtaining the target content rating.

5. The method of claim 4, wherein obtaining the target content rating comprises detecting a user input that indicates the target content rating.

6. The method of claim 3, further comprising determining the target content rating based on an estimated age of a target viewer.

7. The method of claim 6, wherein determining the target content rating based on an estimated age of a target viewer comprises:
determining the estimated age of the target viewer viewing a display coupled with the device; and
determining the target content rating based on the estimated age of the target viewer.

8. The method of claim 6, wherein determining the target content rating based on an estimated age of a target viewer comprises determining the target content rating based on a parental control setting.

9. The method of claim 3, further comprising determining the target content rating based on a geographical location of a target viewer.

10. The method of claim 9, wherein determining the target content rating based on a geographical location of a target viewer comprises:
determining the geographical location of the target viewer viewing a display coupled with the device; and
determining the target content rating based on the geographical location of the viewer.

11. The method of claim 3, further comprising:
determining a time of day; and
determining the target content rating based on the time of day.

12. The method of claim 2, wherein a content rating of the first action is higher than the target content rating.

13. The method of claim 12, wherein obtaining a second action that satisfies the target content rating and that is within a degree of similarity to the first action comprises downrating the first action.

14. The method of claim 2, wherein a content rating of the first action is lower than the target content rating.

15. The method of claim 14, wherein obtaining a second action that satisfies the target content rating and that is within a degree of similarity to the first action comprises uprating the first action.

16. The method of claim 1, further comprising, on a condition that a third action performed by a representations of an agent depicted in the content item satisfies the target content rating, forgoing replacement of the third action in order to maintain the third action in the content item.

17. The method of claim 1, further comprising:
determining an objective that the first action satisfies; and
selecting the second action from a set of candidate actions based on the objective.

18. The method of claim 1, wherein identifying, from the content item, a first action performed by one or more representations of agents depicted in the content item comprises retrieving the first action from metadata of the content item.

19. A device comprising:
one or more processors;
a non-transitory memory; and
one or more programs stored in the non-transitory memory, which, when executed by the one or more processors, cause the device to:
obtain a content item;
identify, from the content item, a first action performed by one or more representations of agents;
determine whether the first action breaches a target content rating; and
in response to determining that the first action breaches the target content rating:
obtain a second action that satisfies the target content rating and that is within a degree of similarity to the first action; and
replace the first action with the second action in order to satisfy the target content rating.

20. A non-transitory memory storing one or more programs, which, when executed by one or more processors of a device, cause the device to:
obtain a content item;
identify, from the content item, a first action performed by one or more representations of agents;
determine whether the first action breaches a target content rating; and
in response to determining that the first action breaches the target content rating:
obtain a second action that satisfies the target content rating and that is within a degree of similarity to the first action; and
replace the first action with the second action in order to satisfy the target content rating.
